(19) United States
(12) Patent Application Publication
(10) Pub. No.: US 2002/0096609 A1
(43) Pub. Date: Jul. 25, 2002

(54) Modular, collapsible base for furniture, particularly conference tables , and the like

(76) Inventor: Frank Venegas JR., Brighton, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/054,122

(22) Filed: Nov. 13, 2001

Related U.S. Application Data
(60) Provisional application No. 60/248,168, filed on Nov. 13, 2000.

(51) Int. Cl. F16M 11/20

(52) U.S. Cl. 248/188.1

(57) ABSTRACT

A table base is assembled from multiple elongated members, including vertical and horizontal members. The members are interconnected by releasable structural fittings.

### REFERENCE TO RELATED APPLICATIONS

This application claims priority from U.S. provisional patent application Serial No. 60/248,168, filed Nov. 13, 2000, the entire contents of which are incorporated herein by reference.

### FIELD OF THE INVENTION

The present invention relates generally to table bases and, more specifically, to a collapsible base for conference tables and other furniture applications.

### BACKGROUND OF THE INVENTION

Tables come in a wide variety of styles, reflecting their owners' desire for functional, interesting, and aesthetically pleasing furnishings. Some tables are constructed as a unitary item while others consist of a base and a separate top which rests on the base. Tables also vary dramatically in size. In business settings, it is often desirable to have a conference table which seats a large number of people. Consequently, the tables are large in size. Partially due to their size, these tables typically consist of a separate base and top wherein the base may consist of one or more separate pieces. This allows the individual pieces to be moved into the room and the table assembled in place. While there are a large number of such designs, there are none that offer the features of the present invention.

### SUMMARY OF THE INVENTION

The present invention provides a collapsible table base assembled from a plurality of horizontal and vertical members interconnected by releasable structural fittings. In one embodiment, the collapsible table base has a top portion disposed in a generally horizontal plane comprised of a plurality of releasably interconnected horizontal members. A support portion supports the top portion in the generally horizontal plane and includes a plurality of elongated members releasable interconnected to one another. The elongated members include leg members having lower ends for engaging the floor. Removable structural fittings releasable interconnect the top portion and support portions so as to form a generally rigid base.

### BRIEF DESCRIPTION OF THE DRAWINGS

FIG. 1 is a top plan view of a table base according to the present invention, with a top shown with broken lines;

FIG. 2 is a bottom plan view of the table base of FIG. 1;

FIG. 3 is a side elevational view of the table base of FIGS. 1 and 2, the opposite side view being identical thereto;

FIG. 4 is an end elevational view of the table base of FIGS. 1-3, the opposite end view being identical thereto;

FIG. 5 is an exploded view of the table base of FIGS. 1-4 showing the components thereof;

FIG. 6 is a detailed perspective view of a portion of the table showing the steel inner tubes, the plastic outer sheathing and one version of a structural fitting for interconnecting tubes;

FIG. 7 is a cross-sectional view showing the use of an inner tube and outer plastic sheathing;

FIG. 8 is an exploded perspective view of a slip-in structural fitting for use with some embodiments of the present invention, and a portion of the tube for connection to the fitting;

FIG. 9 is an exploded perspective view of another alternative structural fitting and a portion of a tube;

FIG. 10 is an exploded perspective view of yet another structural fitting for use with the present invention, along with a portion of a tube and sheathing;

FIG. 11 is a perspective view of an alternative embodiment of a table base according to the present invention utilizing fewer structural members, with a top shown with broken lines;

FIG. 12 is a perspective view of another alternative embodiment of a table base according to the present invention, along with a top;

FIG. 13 is a side elevational view of the table of FIG. 12, the opposite view being identical thereto;

FIG. 14 is an end elevational view of the table of FIG. 12, the opposite end view being identical thereto; and

FIG. 15 is a top plan view of the table of FIG. 12, with the drawing sectioned.

### DETAILED DESCRIPTION OF THE INVENTION

The present invention is directed to table bases constructed from multiple vertical, horizontal, and/or angled members releasably engaged to one another using structural slip-in or slip-on fittings. In some embodiments, replaceable polymerized sheathing surrounds some or all of the members.

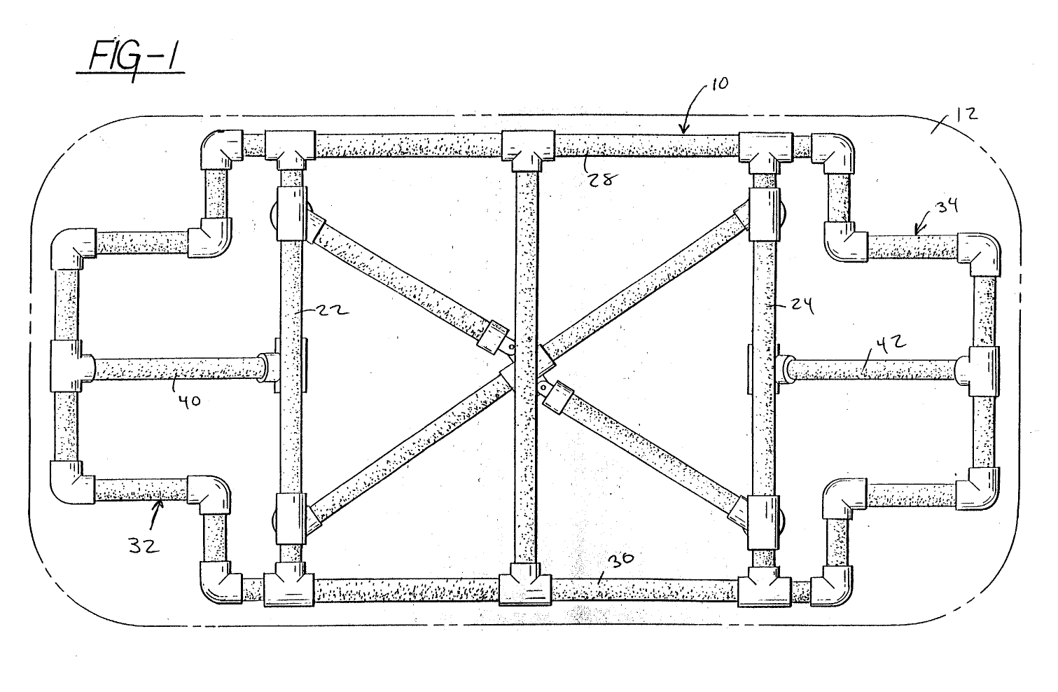

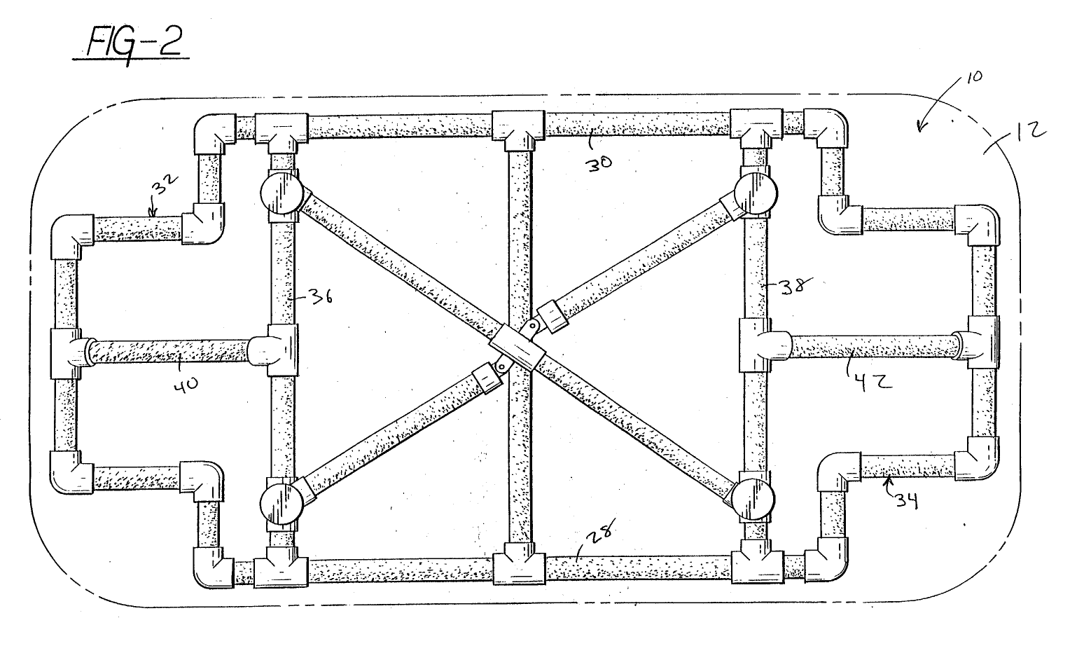

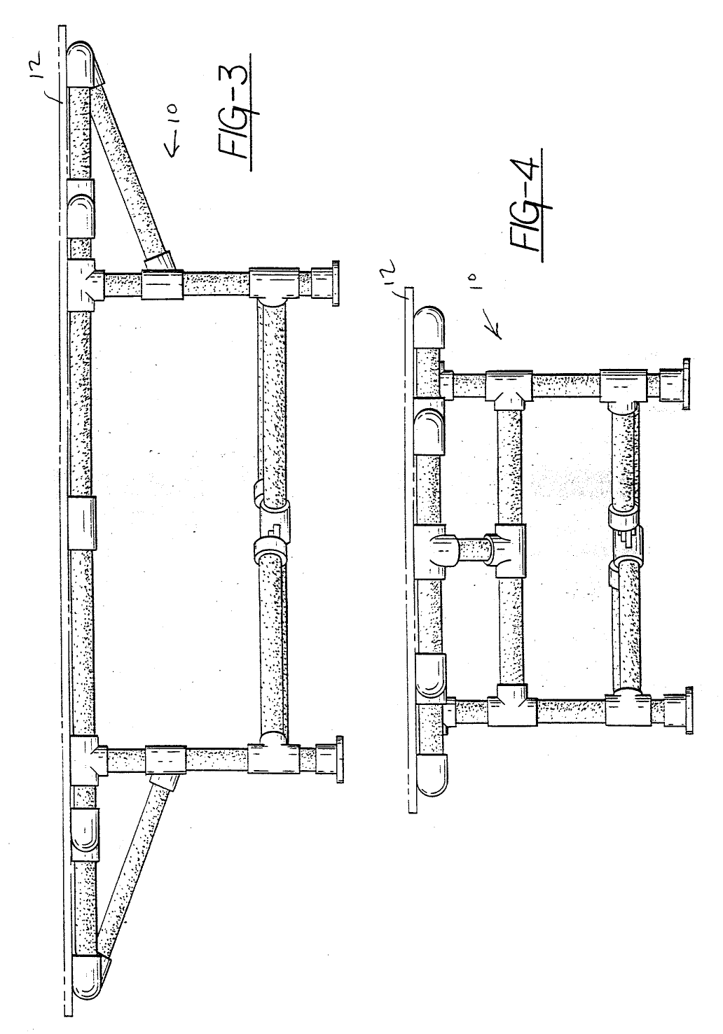

FIGS. 1-5 illustrate a first preferred embodiment of a table base 10 according to the present invention supporting a top 12 in a generally horizontal position. The table base 10 includes a plurality of horizontal, vertical and angular members interconnected with structural fittings so as to form the base. The horizontal, vertical and angular members may be covered with a replaceable polymerized sheathing which may or may not be engaged by the structural fittings. Referring to the first embodiment of the table base 10 in FIGS. 1-5, the base includes four vertical leg members with lower ends configured to contact a floor. For ease of reference, the legs may be defined as a left rear leg 14, a left front leg 16, a right rear leg 18 and a right front leg 20. The table may be said to have a longitudinal axis extending left to right and a lateral axis extending front to rear in FIG. 1. The legs 14-20 may be considered to form part of a support portion of the base 10, with the support portion engaging and supporting a top portion of the table.

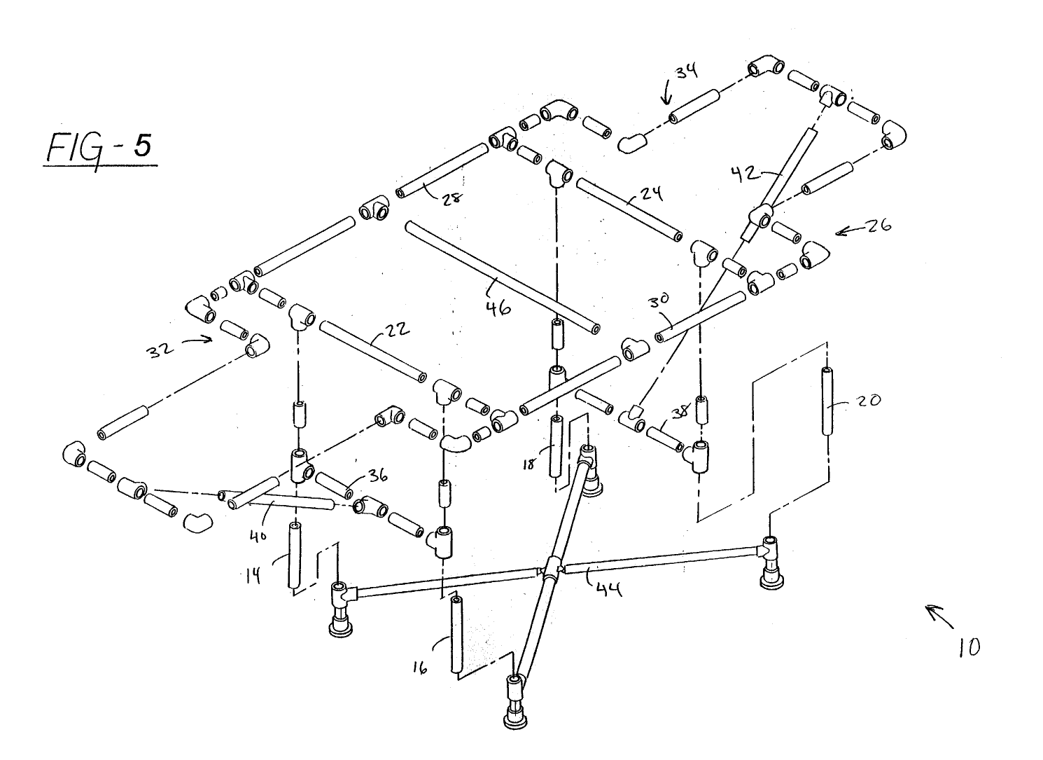

The top portion 26 of the base is formed by multiple interconnected generally horizontal members, all disposed in a generally horizontal plane. In the illustrated embodiment, one horizontal rail 22 is engaged to the upper ends of the left rear leg 14 and left front leg 16. While shown as three pieces in FIG. 5, the horizontal rail 22 may be a single piece or formed of multiple pieces. The same is true for the legs, which are illustrated as multiple pieces but may be formed as single pieces. Another horizontal rail 24 engages the upper ends of the right rear leg 18 and right front leg 20. The horizontal members 22 and 24 are lateral members and preferably extend outboard of where they interconnect with the upper ends of the legs. A perimeter frame or rail system 26 is interconnected with the ends of the horizontal rails 22 and 24 and generally define the outer perimeter of the top portion of the base 10. The top portion 26 includes a pair of a generally parallel, spaced apart, longitudinal, horizontal rails 28 and 30 that extend between the ends of the horizontal rails 22 and 24 and are generally perpendicular thereto. Once again, the rails 28 and 30 may be single pieces or multiple pieces. Preferably, the rails 28 and 30 extend beyond the ends of the rails 22 and 24 and are interconnected with a pair of extension portions 32 and 34.

The extension portions 32 and 34 extend laterally such that they extend significantly beyond the positions of the legs at the two ends of the table. In order to support each of extension portions, support members are provided. In the illustrated embodiment, a first leg brace 36 extends between the left rear leg 14 and left front leg 16 between their upper and lower ends. A support member extends between the outer end of the extension portion 32 and the leg brace 36. Likewise, the leg brace 38 extends between the right rear leg 18 and front right leg 20 and a support member 42 extends between the leg brace 38 and the outermost end of the extension portion 34.

In the various figures, it can be seen that other members may also be provided. For example, a leg cross brace 44 may interconnect all four legs 14-20 near their lower ends. Also, an additional horizontal rail 46 may extend between the longitudinal horizontal rails 28 and 30 midway between the lateral horizontal rails 22 and 24.

Sheathing is preferred, to disguise the use of the member material, also enabling an aesthetically pleasing interchange of different colors, including glow-in-the-dark plastic coverings to be used, as desired. Preferably, a soft sheathing material such as polyethylene or polypropylene is used, though any appropriate material may be substituted.

The use of an outer sheathing on the tubular members is not required, according to the invention, however, in that solid plastic or metal tubular members may themselves be used without a covering. Solid plastic may be used for smaller pieces of furniture and tables, though metal, preferably a non-rusting type of metal such as aluminum, stainless steel or magnesium alloys are used if exposed.

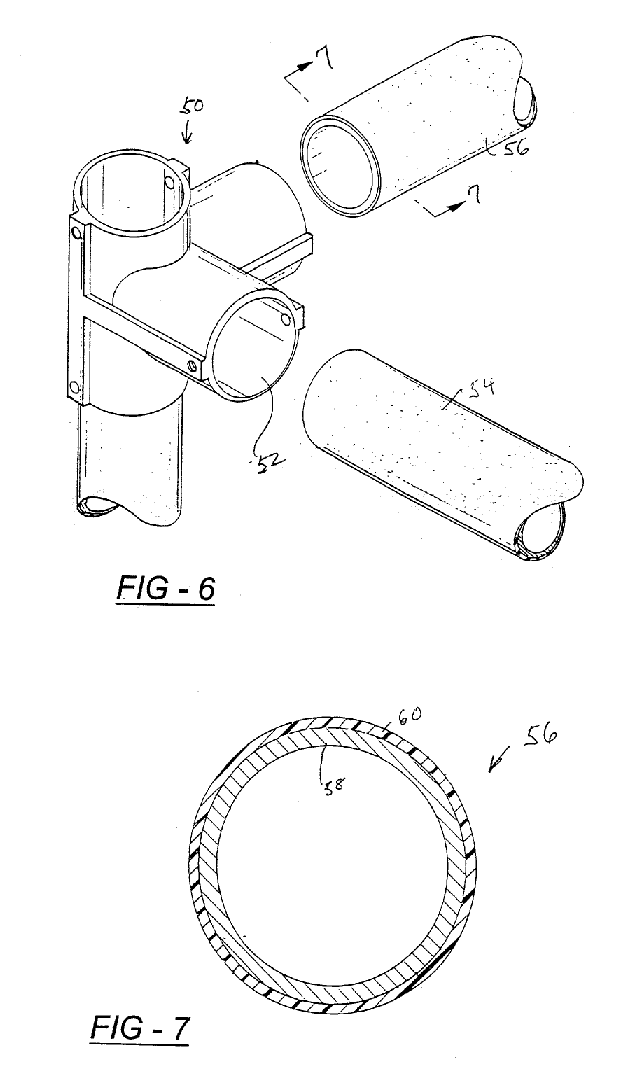

FIG. 6 illustrates one embodiment of a slip-on structural fitting that may be used to interconnect various tubular rails. The illustrated structural fitting 50 is a four-way slip-on structural fitting. However, similar fittings may be provided with two to six or more openings for receiving tubular members. The fitting 50 has legs with a hollow interior 52 with an interior profile matching the outer profile of the tubular members. The interior profile preferably has a diameter equal to or greater than the exterior diagram of the tubes and/or the sheathing that covers them. Tubes 54 and 56 are shown in position to slide into two of the legs of the fitting 50.

FIG. 7 shows a cross-sectional view of one of the tubes 56, which consists of a steel tubular member 58 covered by removable and replaceable polymerized sheathing 60. This sheathing 60 has an inner diameter equal to or greater than the outer diameter of the tubular member 58. In some embodiments, the tubing with the sheathing thereon is slid into the open leg of a structural fitting. A set screw or fastener is then tightened against the outside of the sheathing. In some cases the fastener has a rounded end such that it presses against the sheathing to form a press fit with the rail without penetrating the sheathing.

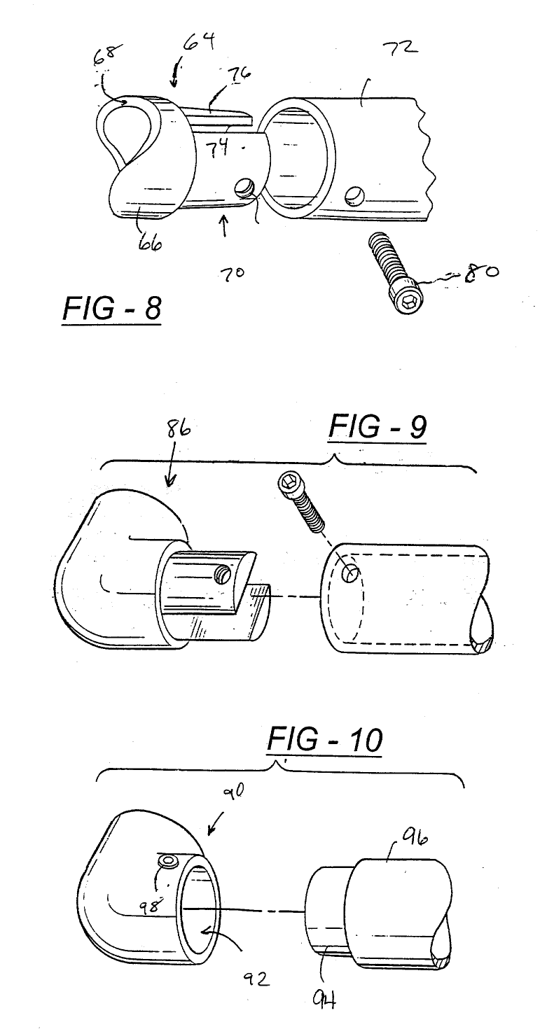

Alternatively, it may penetrate the sheathing. Referring now to FIG. 8, an alternative structural fitting which may be used with various embodiments of the present invention is considered a slip-in structural fitting 64. The fitting has a base 66 that is generally circular in cross-section with a outer diameter preferably the same as the outer diameter of the tubing or sheathing that connects thereto. The base has a radiused end surface 68 that matches the outer diameter of a tube or the sheathing thereon. The radiused end surface 68 is positioned against the outer surface of a tube and a fastener, not shown, connects the base 68 to the tube. The connector 64 also has an engagement member 70 extending from the base for engaging the inner diameter of a tube 72. The engagement member 70 includes a pair of engagement fingers 74 and 76 shaped to fit into the inner diameter of the tube 72. The fingers may be a slip fit or press fit into the tubing 72. Preferably, a fastener 80 passes through a hole in the tube 72 and engages a threaded opening 78 in one of the fingers. The fastener may be tightened such that it engages the inside of the other finger and spreads the two fingers apart, thereby securely engaging the tube 72. The fitting 64 in FIG. 8 may be used to form a T-shaped junction.

FIG. 9 shows an alternative fitting 86 that is elbow-shaped. It is also designed as a slip-in fitting on one of its legs. The other leg may be a slip-on or an additional slip-in style. FIG. 10 shows an elbow-style slip-on structural fitting 90. The opening 92 on one leg of the L-shaped fitting 90 has an inner diameter sized to receive either a tube 94 or the sheathing around the tube 96. A fastener 98 may then be tightened to form a press fit with the tube 94 and/or sheathing 96. The outer diameter of the legs of the fitting 90 may be sized such that it is approximately the same as the outer diameter of the sheathing 96 with the tubing 94 fitting into the opening 92. This arrangement gives a finished look.

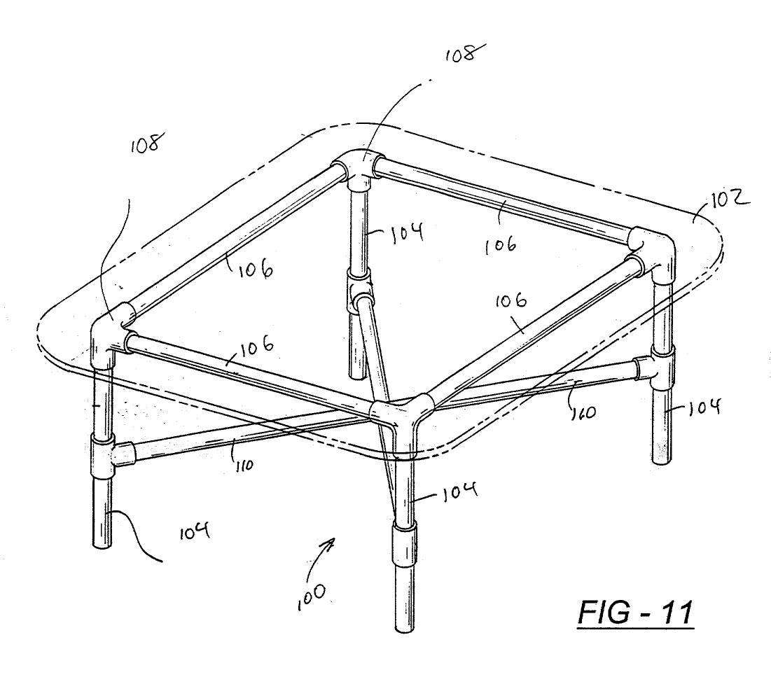

Turning now to FIG. 11, an alternative embodiment of the table base 100 is illustrated supporting a table top 102. This table base 100 is a simplified version of the previous embodiment. It includes four vertical leg members 104 with horizontal members 106 extending between the upper ends of the legs 104. The legs 104 and horizontal members 106 are interconnected with structural fittings 108. Leg cross braces 110 may also be provided. Polymerized sheathing may cover each of the legs 104, horizontal members 106 and cross braces 110. Alternatively, the table base 100 may be constructed without polymerized sheathing.

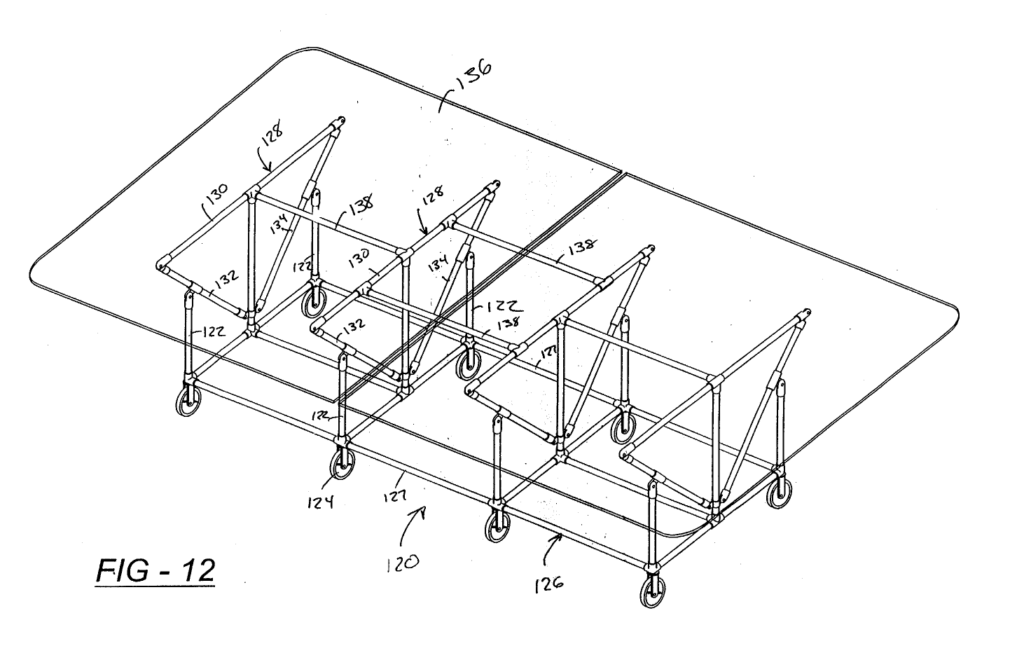

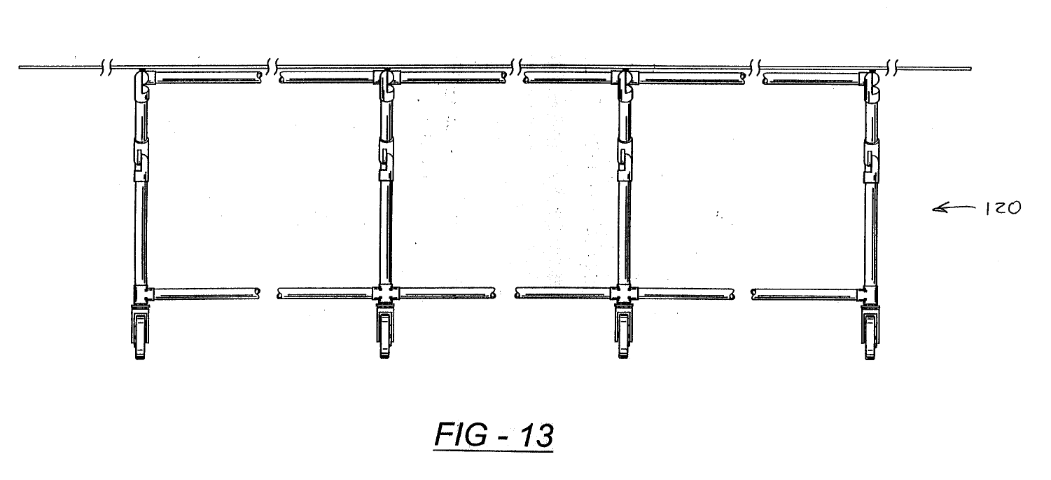

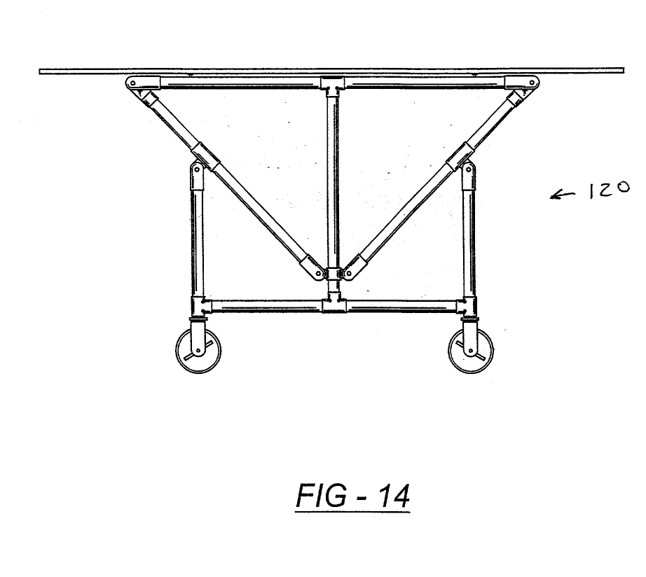

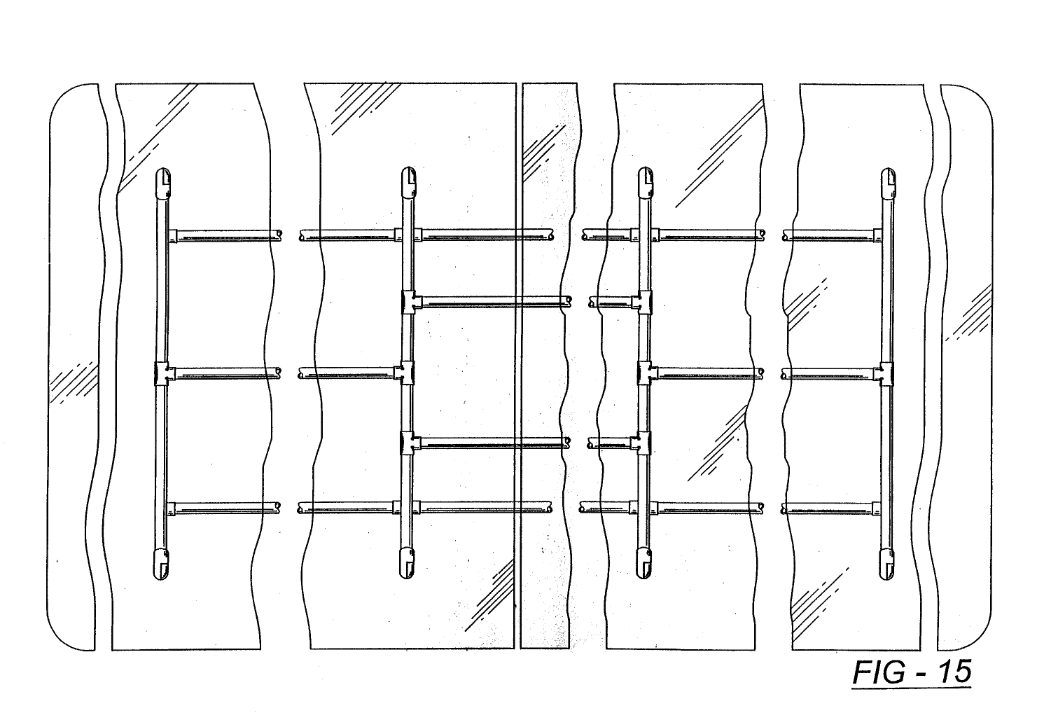

Referring now to FIGS. 12-15, a third embodiment of a table base 120 will be discussed. The base 120 has a plurality of spaced apart generally vertical leg members 122 with lower ends configured to engage a floor. In the illustrated embodiment, the lower ends of the leg members 122 include casters 124. The casters, which may be lockable, allow for easy moving of the table base 120. In alternative embodiments, casters are not included. A lower frame 126 extends between and interconnects the leg members 22 near the lower ends. The frame 126 consists of a plurality of generally horizontal members that extend between the leg members 122 interconnected thereto with structural fittings.

The leg members 122 may be divided into lateral pairs with each supporting a triangular structure 128. Each triangular structure 128 includes a base 130 and a pair of sides 132 and 134 which are interconnected so as to form a triangular shaped structure. The upper ends of the legs 122 are interconnected with the sides 132 and 134 of the triangular structure 128 such that the triangular structure 128 is positioned with the base being horizontal and the sides 132 and 134 angling downwardly therefrom. The sides 132 and 134 join at a downwardly directed point on the centerline of the base. The configuration of the upside down triangular structures 128 provide a support structure for the table top 136 that is laterally wider than the lateral spacing of the legs 122. This allows for more clearance for people sitting around the table. Adjacent triangular structures 128 are preferably interconnected by horizontal interconnection members 138. As shown, more than one interconnection member may be provided, such as shown between the middle two triangular structures. It should be noted that while FIG. 12 illustrates an eight-legged version of the table, smaller versions may be made with fewer legs and a smaller size.

As illustrated, the table top 136 is in two pieces. This eases transport of the top. Also, the base 120 may be disassembled into two separate bases with each separate base supporting half of the original top 136. To split the base merely requires removing two of the horizontal frame members 127 and two of the upper horizontal interconnection members 138. Also, a table base constructed in accordance with FIG. 12 may be provided at any length by providing additional triangular structures and leg pairs, all interconnected with one another. In one embodiment, the table base of FIG. 12 is constructed of tubular metal members interconnected by metal structural slip-on fittings, with no polymerized sheathing. Alternative embodiments may include polymerized sheathing.

The embodiments shown in Figures represent robust, comprehensive designs including numerous elements organized in an aesthetically pleasing, yet functional manner. It will be appreciated, however, that so long as tubular members and connectors are used in accordance with the invention, other assemblies are possible while keeping within the scope and spirit of this disclosure. For example, non-circular members such as square members may alternatively be used. And, in addition, simplified structures may be formed, such as that shown in FIG. 7. Broadly, regardless of the embodiment, tables according to the invention preferably utilize at least three legs interconnected immediately below the table top with couplers along with cross-bracings, as necessary, depending upon the size and weight of the table top.

I claim:

1. A collapsible table base for supporting a table top in a generally horizontal position above a generally horizontal floor, said table base comprising:
a top portion disposed in a generally horizontal plane, the top portion comprising a plurality of releasably interconnected horizontal members;
a support portion for supporting the top portion in the generally horizontal plane, the support portion comprising a plurality of elongated members releasably interconnected to one another, the elongated members including leg members having lower ends for engaging the floor; and
removable structural fittings releasably interconnecting the top portion and the support portion so as to form a generally rigid base.

2. The table base according to claim 1, wherein all of the horizontal and the elongated members are straight.

3. The table base according to claim 1, further comprising replaceable polymerized sheathing surrounding each of the horizontal members and each of the elongated members, the sheathing having an inner diameter equal to or greater than the outer diameter of the members.

4. The table base according to claim 1, wherein each of the horizontal and elongated members are hollow metal tubes.

5. The table base according to claim 4, wherein at least one of the structural fittings comprises a slip-in fitting having a base with a radiused end surface matching the outer diameter of one of the tubes, the fitting further having an engagement member extending from the base, the engagement member configured to engage the inner diameter of one of the tubes.

6. The table base according to claim 5, wherein the slip-in structural fitting further comprises a connector operable to connect the fitting to one of the tubes such that the end surface mates with the outer diameter of the tube.

7. The table base according to claim 5, wherein the base of the slip-in structural fitting has an outer diameter substantially the same as the outer diameter of the tube engaged by the engagement member.

8. The table base according to claim 5, wherein the engagement member comprises a pair of engagement fingers shaped to fit into the inner diameter of the tube engaged by the engagement member.

9. The table base according to claim 4, wherein at least one of the structural fittings comprises a slip-on fitting having an inner diameter greater than or equal to the outer diameter of one of the tubes.

10. The modular office cubicle system according to claim 9, wherein the slip-on structural fitting further comprises a set screw operable to press against the tube such that the fitting grips the tube.

11. A collapsible table base for supporting a table top in a generally horizontal position above a generally horizontal support surface, said table base comprising:
four spaced apart generally vertical legs each having a lower end configured to contact the support surface and an upper end, each of the legs having a height and an outer diameter;
replaceable polymerized sheathing surrounding each of the legs, the sheathing having an inner diameter equal to or greater than the outer diameter of the legs;
a plurality of spaced apart horizontal rails for supporting the table top, said horizontal rails interconnected with the upper ends of the legs, each of the horizontal rails having an outer diameter and a length; and
replaceable polymerized sheathing surrounding each of the horizontal rails, the sheathing having an inner diameter equal to or greater than the outer diameter of the horizontal rails.

12. The table base according to claim 11, wherein said plurality of horizontal rails comprises:
a first pair of parallel spaced apart horizontal rails, each rail extending between the upper end of two of the vertical legs and having a first end and a second end; and
a second pair of parallel spaced apart horizontal rails, one rail extending between the first ends of the first pair of horizontal rails and the other rail extending between the second ends of the first pair of horizontal rails.

13. The table base according to claim 11, further comprising a first leg brace extending between two of said legs between the lower and upper ends thereof, the leg brace having a first end interconnected with one leg and a second end interconnected with the other leg.

14. The table base according to claim 11, wherein the sheathing extends substantially the entire height of the legs and the entire length of the horizontal rails.

15. A collapsible table base for supporting a table top in a generally horizontal position above a generally horizontal support surface, said table base comprising:
four spaced apart generally vertical legs comprising a left front corner leg, a right front corner leg, a left rear corner leg, and a right rear corner leg, each of the legs having a lower end configured to contact the support surface and an upper end;
a first pair of parallel spaced apart horizontal rails, one rail extending between the upper end of the left rear corner leg and the upper end of the left front corner leg, the other rail extending between the right rear corner leg and the right front corner leg, each of the rails having a front end and a rear end;
a second pair of parallel spaced apart horizontal rails, one rail extending between the front ends of the first pair of horizontal rails and the other rail extending between the rear ends of the first pair of horizontal rails, each of the second pair of horizontal rails having a left end and right end;
a first leg brace having a first end interconnected with the left rear leg brace between the upper and lower ends thereof and a second end interconnected with the left front leg brace between the upper and lower ends thereof, the first leg brace having a midportion between the first and second ends; and
an extension portion having a horizontal member having ends interconnected with the left ends of the second pair of horizontal rails and a midportion therebetween, the extension portion further having a support member extending between the midportion of the first leg brace and the midportion of the horizontal member.

16. A collapsible table base for supporting a table top in a generally horizontal position above a generally horizontal support surface, said table base comprising:
a support portion comprising four spaced apart generally vertical legs comprising a left front corner leg, a right front corner leg, a left rear corner leg, and a right rear corner leg, each of the legs having a lower end configured to contact the support surface and an upper end;
a horizontal top portion supported by the support portion, the top portion comprising a first pair of parallel spaced apart horizontal rails, one rail extending between the upper end of the left rear corner leg and the upper end of the left front corner leg, the other rail extending between the right rear corner leg and the right front corner leg, each of the rails having a front end and a rear end disposed outboard of the legs; and
a perimeter rail system interconnected with the front and rear ends of the horizontal rails and defining the outer perimeter of the table base, the perimeter rail system and the horizontal top portion being disposed in a generally horizontal plane.

17. A collapsible table base for supporting a table top in a generally horizontal position above a generally horizontal floor, said table base comprising:
a plurality of generally vertical leg members having lower ends configured to contact the floor and upper ends spaced therefrom;
a plurality of triangular structures each having a base member and a pair of side members interconnected with structural fittings so as to define a generally triangular shape, each of the side members of the triangular structures being interconnected with the upper end of one of the legs, the triangular structures being supported by the legs such that the bases are disposed in a generally horizontal plane with the side members angling downwardly therefrom; and
a plurality of releasable structural fittings removably interconnecting the leg members with the triangular structures so as to form a generally rigid base.
